(19) United States
(12) Patent Application Publication
(10) Pub. No.: US 2023/0001469 A1
(43) Pub. Date: Jan. 5, 2023

(54) SYSTEM AND METHOD FOR PRODUCING A TRAILER WHEEL

(71) Applicant: New Century Industries, Inc., Paramount, CA (US)

(72) Inventor: Michael Mason, Paramount, CA (US)

(21) Appl. No.: 17/852,570

(22) Filed: Jun. 29, 2022

Related U.S. Application Data
(60) Provisional application No. 63/218,256, filed on Jul. 2, 2021.

(51) Int. Cl. B21D 53/26; B60B 3/00

(52) U.S. Cl. CPC B21D 53/268; B60B 3/007

(57) ABSTRACT

This application describes the creation of a wheel disc for a trailer using a three-hit manufacturing process.

### CROSS-REFERENCE TO RELATED APPLICATION

The present application claims priority to U.S. Provisional Patent Application No. 63/218,256 entitled System and Method for Producing a Trailer Wheel, filed on Jul. 2, 2021, the entire disclosure of which is hereby incorporated by reference in its entirety.

### BACKGROUND

Trailer wheel disc manufacturing typically includes a blanking process, a forming process and a spoking process. The forming process typically requires two separate hits from a hydraulic or mechanical press. Likewise, the spoking process requires the wheel disc to be pierced by a cutting tool for each spoke, one spoke at a time. Thus, an eight-spoke wheel requires eight additional hits by a cutting tool while a ten spoke wheel would require ten additional hits by the cutting tool. Each hit that is performed adds manufacturing time and cost.

### SUMMARY

The present application describes a system and method for producing a wheel disc for a trailer in three operations or hits. This is in contrast to standard wheel disc manufacturing processes that typically take upwards of eleven different operations or hits.

Accordingly, the present application describes method for manufacturing a wheel disc for a trailer wheel. In an example, the method includes causing performance of a single blanking operation in which a diameter of a wheel disc, a center bore and a plurality of spokes are pierced into a wheel disc blank the same time. Each of the plurality of spokes has a first set of dimensions and the center bore has a first diameter. Upon completion of the blanking operation, an outer flange of the wheel disc blank is secured to a form die. A single forming operation is then performed in which at least a portion of a material of the wheel disc blank moves from the center bore toward the outer flange of the wheel disc blank and through a rib associated with a lug embossment in the formed torque ring. The forming process causes the plurality of spokes to have a second set of dimensions and also causes the center bore to have a second diameter. A single piercing operation is then performed in which a lug hole is formed in the lug embossment. The center bore may also be pierced to its final diameter in the single piercing operation. In an example, the final diameter may be greater than the second diameter.

The present application also describes a method for manufacturing a wheel disc for a trailer wheel. In an example, this method includes performing a blanking operation in which a center bore and a spoke, along with a shape and/or diameter of the wheel disc is pierced and/or cut to form a wheel disc blank. Upon the completion of the blanking operation, a forming operation causes a material of the wheel disc blank to move from the center bore toward an outer flange of the wheel disc blank through a rib associated with a lug embossment. A lug hole is pierced in each lug embossments in a piercing operation.

Also described is a wheel disc for a trailer. In an example, the wheel disc includes a center hole defined by an inner portion of the wheel disc, a plurality of spokes are pierced around the center bore, and a torque ring is formed around the center bore. In an example, a conical angle of the wheel disc is at least fifteen degrees. Additionally, the center bore and the plurality of spokes are pierced in a single first operation, the conical angle of the wheel disc and the torque ring are formed in a single second operation, and the plurality of lug holes and a center bore are pierced in a single third operation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates a wheel disc blank having an outer contour and/or an outer diameter in which a center bore and a plurality of spokes have been formed in a single hit or blanking operation according to an example.

FIG. 2 illustrates the wheel disc blank of FIG. 1 after a forming operation has been performed to create a wheel disc according to an example.

FIG. 3 illustrates the wheel disc of FIG. 2 in which lug holes have been pierced into lug embossments and the center bore has been pierced to its final diameter according to an example.

FIG. 4 illustrates a rib and torque ring embossment formed on one side of a wheel disc between a lug embossment and a conical face of the wheel disc according to an example.

FIG. 5A illustrates a wheel disc blank being mounted into a press and form die before impact according to an example.

FIG. 5B illustrates an outer flange of the wheel disc blank being secured to the press and form die during a forming process according to an example.

FIG. 6 illustrates a method for forming a wheel disc for a trailer according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Trailer wheel disc manufacturing is a time-consuming process and typically includes multiple steps. For example, once a wheel disc blank is formed (e.g., using a die and a press) the wheel disc blank is placed on the form die for an initial forming process. During the forming process, a press (e.g., a mechanical press, a punching press, a hydraulic press) typically hits the wheel disc blank at least two different times in order to form the wheel disc blank into its' final conical shape (with torque ring). Once the wheel disc blank has been formed into the conical shape (with torque ring), a spoking process occurs.

During the spoking process, a conical cutting edge of the press hits or otherwise contacts a first area of the wheel disc to pierce a first spoke. The wheel disc is rotated and the process repeats for the second wheel spoke. This cutting process continues until the desired number of spokes have been cut into the wheel disc. Thus, for an eight-spoke wheel disc, eight different hits are required. For a ten spoke wheel disc, ten different hits are required.

Once the spoking process is complete, lug holes and a center bore are pierced in the wheel disc. This process requires the punching press to perform another hit on the wheel disc. Thus, in total, at least twelve different hits (e.g., at least one hit to create the wheel disc blank, two hits for the forming process, eight to ten hits for the spoking process and piercing the center bore and one hit for piercing the lug holes) on the wheel disc are typically required. Each required hit increases manufacturing time, increases the manufacturing costs and increases the wear and tear on the machinery (e.g., cutting tool, die) that is used to form the wheel disc.

In order to address the above, the present application describes a three-hit process for forming a wheel disc for a trailer. Although the examples described herein relate to a wheel disc for a trailer, other implementations are possible.

As will be explained in greater detail below, the three-hit process includes a single blanking operation in which a press (e.g., a hydraulic press, a punching press, or other cutting/piercing mechanism) causes a wheel disc blank having an outer diameter to be pierced. In addition, during the blanking operation, a center bore and a plurality of spokes or windows are cut, pierced or otherwise formed into the wheel disc blank. The center bore has a first diameter and each of the spokes has a first set of dimensions. Once the center bore and the plurality of spokes have been pierced into the wheel disc blank, a single forming operation is performed.

As part of the forming operation, an outer flange of the wheel disc blank is secured to a form die of a press. Because the outer flange of the wheel disc blank is secured to (or formed with) the form die, the metal (or other material(s)) that comprise the wheel disc blank flows from the center bore radially outward toward the outer flange of the wheel disc blank (instead of moving from the outside of the wheel disc blank toward the center of the wheel disc blank as is the case in current forming processes). In addition, a rib is formed adjacent to and/or integrated with a lug embossment that is also formed in the wheel disc blank. The forming process may also cause the plurality of spokes to have a second set of dimensions and may also cause the center bore to have a second diameter due to the flow of material. A single piercing operation is then performed in which a lug hole is pierced in the lug hole emboss. The single piercing operation may also pierce the center bore to a final diameter.

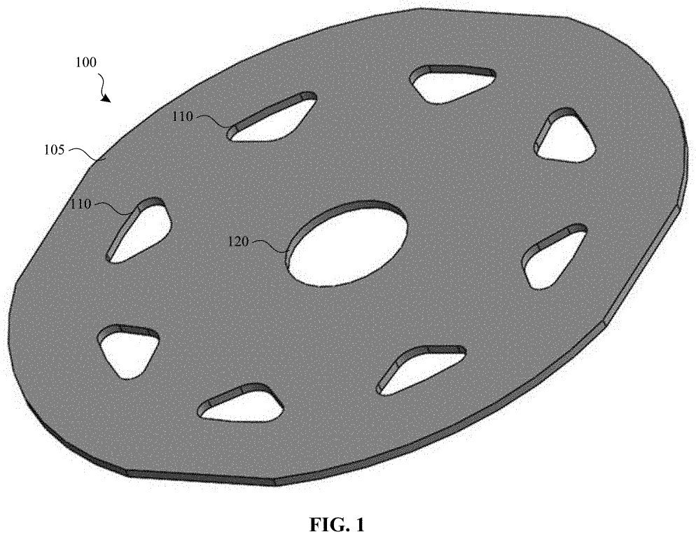

These and other examples will be shown and described in more detail with respect to FIG. 1-FIG. 6.

FIG. 1 illustrates a wheel disc blank 105 for creating wheel disc 100 according to an example. In an example, the operations described herein may be used for wheel discs having a finished diameter greater than or equal to twelve inches discs made for wheels for 14 inches and above. (e.g. twelve point four inches, fourteen inches) and having a conical angle of fifteen degrees or more.

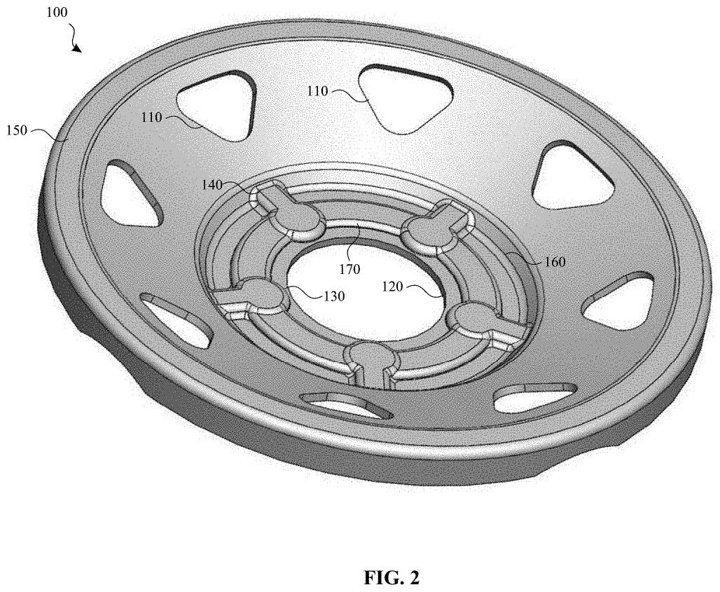

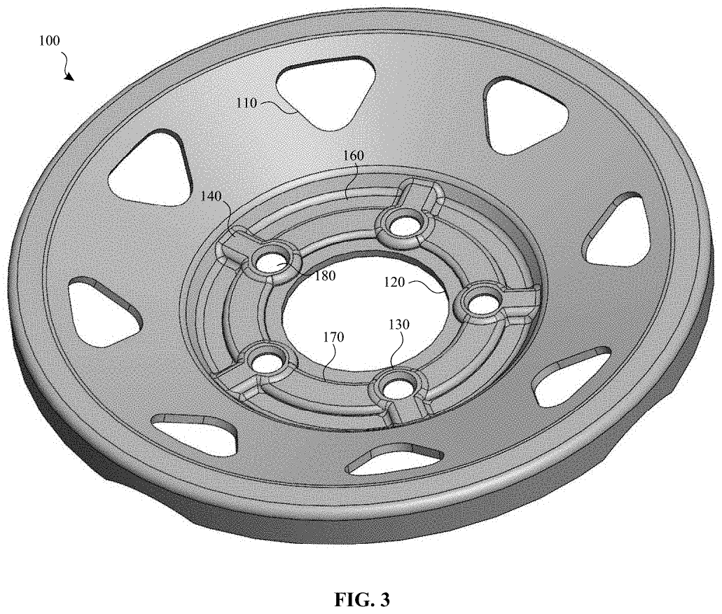

As shown in FIG. 1, a center bore 120 and a plurality of spokes 110 have been pierced into the wheel disc blank 105 in single blanking operation. The single blanking operation may also define the outer diameter of the wheel disc blank 105. In an example, the outer diameter of the wheel disc blank may be different than a diameter of the conical wheel disc (e.g., the wheel disc shown in FIG. 2 and FIG. 3).

Although the wheel disc blank 105 is shown with eight triangular spokes 110, the wheel disc blank 105 may have any number of spokes in a variety of different shapes. For example, the wheel disc blank 105 may include ten circular spokes. In an example, the shape of the spokes and/or the number of spokes should not deform the wheel disc blank 105 to an extent that it is not usable due to material thinning beyond a threshold.

Unlike typical solutions in which individual spokes are added one at a time and after a forming process (e.g., after the wheel disc blank has been formed into a conical shape), the spokes 110 and the center bore 120 are pierced into or are otherwise defined by the wheel disc blank 105 prior to any forming operation. Additionally, each of the spokes 110 and/or the center bore 120 may be cut, pierced in the wheel disc blank 105 in a single operation or process. As discussed above, the diameter of the wheel disc blank may also be defined during this process.

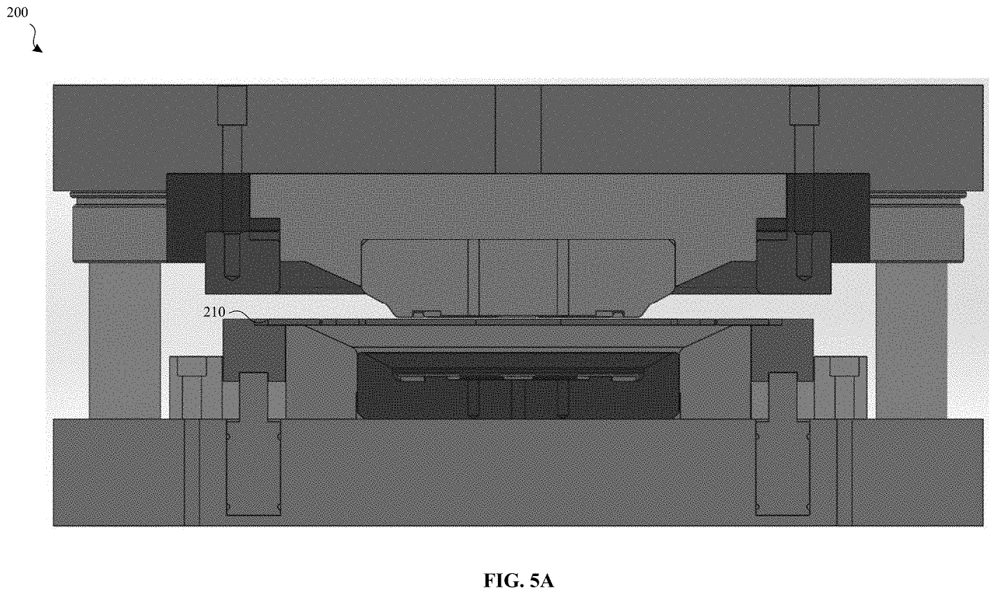

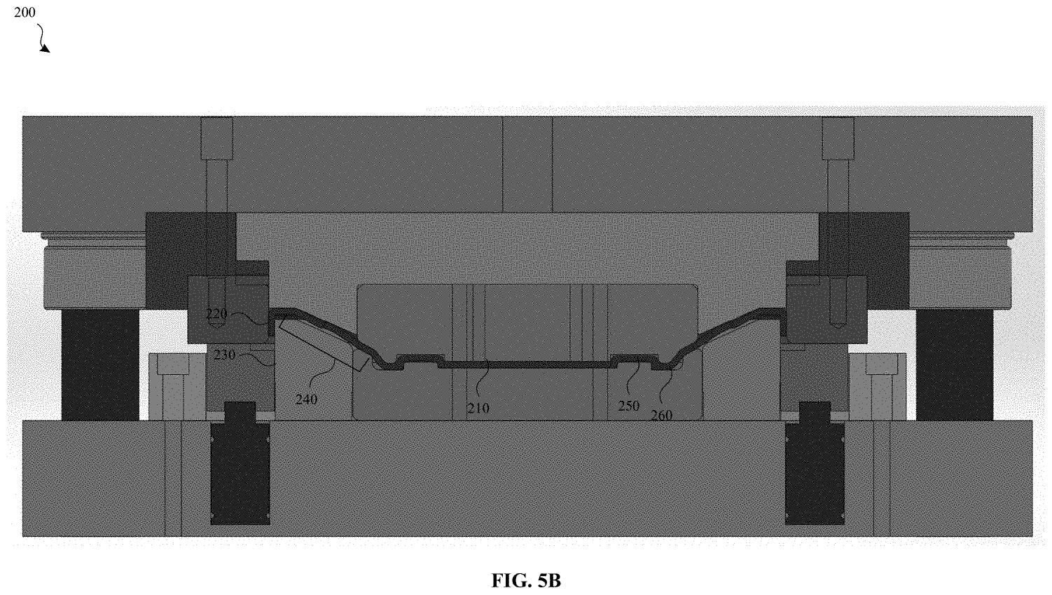

For example, a substantially planar wheel disc blank 105 (or a piece of sheet metal or other material) may be mounted to a press (e.g., a hydraulic press, a mechanical press, a punching press) and/or an associated form die (e.g., the press 200 and associated form die shown in FIG. 5A and FIG. 5B). Once the wheel disc blank 105 has been mounted to the press, the press performs a single blanking operation that blanks the outer diameter, the spokes 110 and/or the center bore 120 in the wheel disc blank 105. Thus, the blanking operation blanks the outer diameter, the center bore 120 and/or each of the plurality of spokes 110 simultaneously or substantially simultaneously.

Because the wheel disc blank 105 is planar or substantially planar, the cutting tool that blanks the outer diameter, the spokes 110 and/or the center bore 120 may also be planar or substantially planar. This is in contrast to current solutions in which a conical disc is held at an angle to position a surface of the conical disc is substantially parallel with respect to a cutting too. The cutting tool then pierces the conical disc at that position. Additionally, in current solutions, the cutting die only cuts one spoke into a formed wheel disc at a time. In contrast, the present disclosure enables multiple spokes to be pierced, cut into the wheel disc blank 105 simultaneously or substantially simultaneously on a flat, or planer surface.

As shown in FIG. 1, the single punching operation causes the center bore 120 to have a first shape and/or a first diameter (or other set of dimensions). Likewise, the single punching operation causes each of the spokes 110 to have a first shape and/or a first set of dimensions. In an example, the shape and/or associated dimensions of the center bore 120 and/or each of the spokes 110 is based, at least in part, on a desired shape and/or set of dimensions of the center bore 120 and/or the spokes 110 once a forming process (shown and described with respect to FIG. 2) has been completed.

For example and referring to FIG. 2, FIG. 2 illustrates the wheel disc 100 of FIG. 1 after a single forming operation has been performed. In an example, the forming operation may cause a conical angle of wheel disc 100 to be fifteen degrees or more. When comparing the shape and/or first set of dimensions of the center bore 120 and/or the spokes 110 in FIG. 1 with those shown in FIG. 2, the center bore 120 and/or the spokes 110 have a second diameter and/or a second set of dimensions. The change from the first set of dimensions to the second set of dimensions occurs as part of the single forming operation.

For example, as the wheel disc blank 105 is formed into the wheel disc 100 (e.g., a wheel disc 100 having a conical shape such as shown in FIG. 2 and a conical angle of fifteen degrees or more), an outer flange 150 of the wheel disc blank 105 is formed to the lower die. Forming the outer flange 150 of the wheel disc blank 105 to the lower die locks the material between the upper and lower form tools and enables the forming operation to occur in a single hit or operation. As a result of the outer flange 150 of the wheel disc blank 105 being formed to the die, a material (e.g., metal) from which the wheel disc blank 105 is comprised, forms from the inside out (instead of from the outside in which is standard in current solutions) and locks the material in place such that the material takes the path of least resistance. During this forming operation, the dimensions of the spokes 110 and/or the center bore may change.

For example, as the substantially planar wheel disc blank 105 of FIG. 1 is formed to the conical shape shown in FIG. 2, the metal of the wheel disc blank 105 flows radially outward (e.g., from the inside of the wheel disc blank 105 toward the conical face 160 of wheel disc blank 105). As a result, a diameter of the center bore 120 becomes larger when compared with the first diameter of the center bore 120. Additionally, the dimensions of the spokes 110 may change from having a first set of dimensions to a second set of dimensions or may remain relatively unchanged.

In an example, the change in the diameter of the center bore 120 and/or the spokes 110 between the blanking operation and the forming operation may be measured or otherwise determined. Thus, if the resulting shape and/or dimensions of the center bore 120 and/or the spokes 110 is to be changed, an original shape and/or dimensions of the center bore and/or the spokes may be adjusted in the blanking process.

The forming operation, in combination with the metal flowing from the inside out of the wheel disc 100 also enables the metal to flow over lug forming inserts of the form die to form one or more lug embossments 130 at or near a torque ring of the wheel disc 100. The form die also enables the lug embossments 130 to be associated with or are otherwise formed with a rib 140. The rib 140 extends from a base of the lug embossments 130 outward and/or toward the conical face 160 of the disc wheel 100. This rib 140 assists the flow of metal during the forming operation such that the lug embossment 130 has sufficient material to prevent cracking. A torque ring embossment 170 may also be formed or otherwise extend between each of the lug embossments 130 and/or ribs 140. The torque ring embossment 170 may serve as a stiffening feature for the wheel 100 and/or strengthen a rigidity of the lug protrusions 130.

In an example, if the outer flange 150 of the wheel disc blank 105 was not formed up in the form die, the metal of the wheel disc blank 105 would flow from the outside in. As a result, there would not be enough metal to sufficiently flow over and around the die to provide a requisite amount of rigidity and strength for the lug embossments 130. However, since the outer flange 150 of the wheel disc blank 105 is formed down in the form die, the metal flows radially outward (thereby enlarging the center bore 120). Flow of the metal in this manner/direction helps ensure that enough material is present to form the lug embossments 130 and the torque ring embossment 170. Additionally, the rib 140 of each lug embossments 130 also assists with the flow.

FIG. 3 illustrates the wheel disc 100 of FIG. 2 in which lug holes 180 have been pierced in each lug embossments 130 according to an example. Once the wheel disc has been formed, a piercing operation is performed in which lug holes 180 are pierced or cut in wheel disc 100. As with the other processes described above, piercing, cutting or otherwise forming the lug holes 180 in each lug embossments 130 occurs in a single hit or operation. For example, a press may pierce and coin each lug hole 180 in each lug embossment 130 simultaneously or substantially simultaneously. In an example, the piercing operation may also pierce the center bore 120 such that the center bore 120 has a final diameter. In an example, the final diameter of the center bore 120 may be greater than the second diameter.

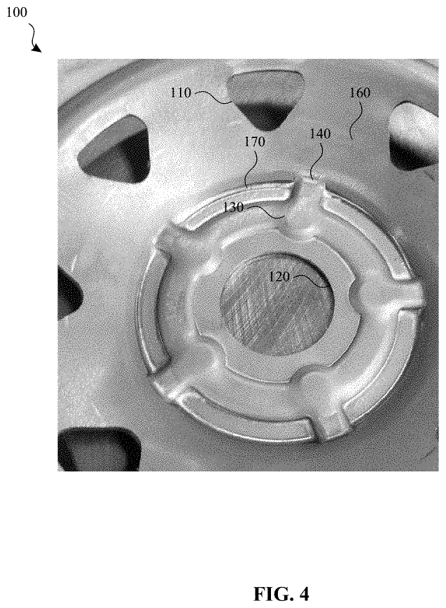

FIG. 4 illustrates a torque ring embossment 170 and rib 140 formed on one side of a wheel disc 100 between a lug embossments 130 and a conical face 160 of the wheel disc 100 according to an example.

As shown in FIG. 4, the rib 140 extends outward from the lug embossment 130 toward the conical face 160 of the wheel disc. This rib 140 enables metal to flow more freely from the center bore 120 toward the outer flange 150 of the wheel disc 100 during a forming operation such as described above. The rib 140 may also assist in the formation of the torque ring embossment 170 that adds additional strength to the wheel disc 100. In an example, the rib 140 may have a draft angle, be drafted or otherwise have a shape and/or angular orientation such that a proximal end of the rib 140 transitions outward to the conical face 160 of the wheel disc 100.

FIG. 5A illustrates a wheel disc blank 210 being mounted on a press 200 and associated form die according to an example. The press 200 may be any type of press capable of performing the blanking operation, the forming operation and the piercing operation described herein. The wheel disc blank 210 may be similar to the wheel disc blank 105 shown and described with respect to FIG. 1-FIG. 3. The wheel disc blank 210 may be mounted to the die and/or press 200 as part of a blanking operation, a forming operation and/or a piercing operation such as described herein.

FIG. 5B illustrates an outer flange 220 of the wheel disc blank 210 being secured to a form die 230 of the press 200 during one or more of the various operations described above according to an example. As shown in FIG. 5B, as the press 200 moves from an open position shown in FIG. 5A to the closed position shown in FIG. 5B as part of the various operation(s) described above, the outer flange 220 of the wheel disc blank 210 is secured to an outer portion of the form die 230.

As a result, the material that comprises the wheel disc blank 210 flows from the inside out such as previously described. This enables the material of wheel disc blank 210 to flow up and around the portions of the form die 230 that cause the formation of the lug protrusions 250 and the rib 260. In the example shown in FIG. 5B, the conical angle 240 of the wheel disc is fifteen degrees or more and the diameter of the wheel disc may be twelve inches or more.

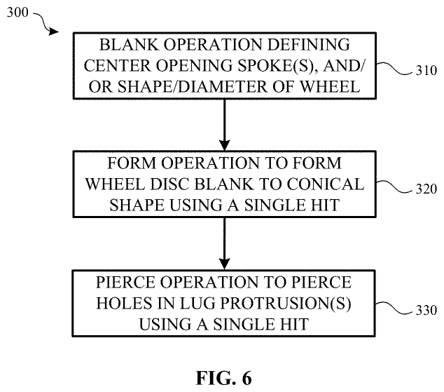

FIG. 6 illustrates a method 300 for forming a wheel disc for a trailer according to an example. The method 300 shown and described may be used to form the wheel disc 100 shown and described with respect to FIG. 1-FIG. 3. In an example, the method 300 may be used to form wheel discs having a diameter of twelve inches (e.g., twelve point four inches) or more and/or with a conical angle of fifteen degrees or more using a three-hit manufacturing process.

Method 300 begins when blanking operation pierces, cuts or otherwise defines a center bore, an outer diameter of the wheel disc blank, and/or one or more spokes (310) in a wheel disc blank. In an example, the blanking operation creates a center bore and/or the spokes in a single operation. For example, a press may pierce, cut or otherwise define the center bore and/or the spokes in the wheel disc blank in a single hit or operation.

Upon completion of the blanking operation, the wheel disc blank is formed (320) into a conical/dish shape using a single forming operation or hit. In an example and as part of the forming process, an outer flange of the wheel disc blank may be formed or otherwise secured to an outer edge or portion of a form die associated with the press. As a result of this forming, material of the wheel disc blank may stretch and/or flow radially outward and/or around various portions of the form die that form the shape, protrusions (e.g., lug protrusions) and features (e.g., torque ring embossment and/or rib) of the wheel disc.

When the wheel disc is formed, a piercing operation pierces (330) lug holes in each lug protrusion and may also pierce the center bore. Like the other two operations described above, the lug holes in each lug protrusion and the center bore are pierced in a single hit or operation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for manufacturing a wheel disc for a trailer wheel, comprising:
causing performance of a single blanking operation in which a center bore and a plurality of spokes are pierced into a wheel disc blank, each of the plurality of spokes having a first set of dimensions and the center bore having a first diameter;
securing an outer flange of the wheel disc blank to a form die;
causing performance of a single forming operation in which at least a portion of a material of the wheel disc blank moves radially outward from the center bore and through a rib associated with a lug protrusion toward the outer flange of the wheel disc blank, the forming operation causing the plurality of spokes to have a second set of dimensions and the center bore to have a second diameter; and
causing performance of a single piercing operation in which a lug hole is pierced in the lug protrusion and the center bore is pierced to a final diameter.

2. The method of claim 1, wherein the single forming operation causes at least a portion of the material of the wheel disc blank to flow and stretch into the lug protrusion.

3. The method of claim 1, wherein the wheel disc has a diameter greater than or equal to twelve inches after the forming operation.

4. The method of claim 1, wherein a conical angle of the wheel disc is at least fifteen degrees.

5. The method of claim 1, wherein the rib is associated with a torque ring embossment.

6. The method of claim 1, wherein securing the outer flange of the blank to the form die causes the material of the wheel disc blank to move radially outward from the center bore via the rib.

7. The method of claim 1, wherein the center bore has a second diameter based, at least in part, on the material of the wheel disc blank moving and stretching radially outward from the center bore.

8. A method for manufacturing a wheel disc for a trailer wheel, comprising:
blanking a center bore and a spoke into a wheel disc blank in a first operation;
causing a material of the wheel disc blank to move radially outward from the center bore via a rib associated with a lug protrusion in a second operation; and piercing a lug hole in the lug protrusion and the center bore in a third operation.

9. The method of claim 8, wherein the center bore has a first diameter at a completion of the first operation, has a second, different diameter at a completion of the second operation, and has a third, final diameter at a completion of the third operation.

10. The method of claim 8, wherein the spoke has a first dimension at a completion of the first operation and has a second, different dimension at a completion of the second operation.

11. The method of claim 8, wherein the rib is associated with a torque ring embossment.

12. The method of claim 8, wherein the wheel disc has a diameter greater than or equal to twelve inches.

13. The method of claim 8, wherein a conical angle of the wheel disc is at least fifteen degrees.

14. The method of claim 8, further comprising forming an outer flange of the wheel disc blank to a form die during the second operation.

15. The method of claim 14, wherein forming the outer flange of the wheel disc blank to the form die causes the material of the wheel disc blank to move radially outward from the center bore via the rib.

16. The method of claim 8, wherein the rib includes a draft angle with respect to an conical face of the wheel disc.

17. A wheel disc for a trailer, comprising:
a center bore provided in an conical face of the wheel disc;
a plurality of spokes positioned around the center bore; and
a plurality of lug holes formed around the center bore, wherein:
a conical angle of the wheel disc is at least fifteen degrees;
the center bore and the plurality of spokes are formed in a single blanking operation;
the conical angle of the wheel is formed in a single forming operation; and
the plurality of lug holes are pierced in a single piercing operation.

18. The wheel disc of claim 17, wherein the wheel disc has a diameter of twelve inches or more.

19. The wheel disc of claim 17, wherein a diameter of the center bore increases as part of the single piercing operation.

20. The wheel disc of claim 17, further comprising a rib between each of the plurality of lug holes and a conical face of the wheel disc.
